(19) United States
(12) Patent Application Publication
(10) Pub. No.: US 2024/0165446 A1
(43) Pub. Date: May 23, 2024

(54) BATTERY FIRE SUPPRESSION COMPOSITION, METHOD OF MANUFACTURE, AND OF USE

(71) Applicant: E-FireX, Reno, NV (US)

(72) Inventor: Jesse W. Corletto, Reno, NV (US)

(21) Appl. No.: 17/991,677

(22) Filed: Nov. 21, 2022

(51) Int. Cl. A62D 1/00

(52) U.S. Cl. CPC A62D 1/0035

(57) ABSTRACT

A full length body pillow includes a weighted core that may contain a variety of materials such as sand, glass beads, plastic pellets, etc. The filling is sewn into a quilt-like pattern to form the core, which is then sewn into the center of the body pillow. After stuffing both halves of the pillow with fill (down, polyester, feathers, memory foam, etc.) the pillow is sealed off at a final weight of roughly 8-10 lbs.

### FIELD OF THE INVENTION

The present invention relates, in general, to fire suppression compositions and methods, and, in particular, to lithium-ion battery fire suppression compositions and methods.

### BACKGROUND OF THE INVENTION

An existing approach to suppress lithium-ion battery fires is to use water to suppress the fire until the lithium-ion battery fire is completely out. This can take from one hour to half of a day, depending on the amount of cooling the thermal run-away needs. Additionally, as reported on page 45 of the Lithium-Ion Batteries Hazard and Use Assessment Final Report by The Fire Protection Research Foundation (dates July 2011), “[E]xponent is not aware of any fire protection standards specific to lithium-ion cells.” With lithium-ion batteries becoming more common in EV vehicles and electronic consumer products, the frequency and resulting harm caused by lithium-ion battery fires will increase.

### SUMMARY OF THE INVENTION

An aspect of the disclosure involves a battery fire suppression composition comprising vermiculite ore concentrate (“VCX”).

In one or more implementations of the above aspect, the battery fire suppression composition is an unformulated, liquid composition; the battery fire suppression composition comprises VCX mixed with water; the battery fire suppression composition comprises 98% VCX mixed and 2% water; the battery fire suppression composition comprises VCX powder; the battery fire suppression composition comprises 100% VCX; and/or the battery fire suppression composition is a lithium-ion battery fire suppression composition configured to suppress a lithium-ion battery fire.

Another aspect of the disclosure involves a method of making a battery fire suppression composition comprising providing VCX.

In one or more implementations of the immediately above aspect, the method of making a battery fire suppression composition comprises mixing VCX with water to make an unformulated, liquid composition; mixing 98% VCX with 2% water to make the unformulated, liquid composition; making the battery fire suppression composition with a VCX powder; making the fire suppression composition comprising 100% VCX; and/or the battery fire suppression composition is a lithium-ion battery fire suppression composition configured to suppress a lithium-ion battery fire.

A further aspect of the disclosure involves a method of suppressing a fire comprising applying a fire suppression composition including a vermiculite ore concentrate (“VCX”) to the fire until the fire is suppressed.

In one or more implementations of the immediately above aspect, the method of suppressing a fire comprises suppressing the battery fire with VCX until the battery fire is suppressed; suppressing the battery fire with an unformulated, liquid composition including VCX; suppressing the battery fire with an unformulated, liquid composition including VCX mixed with water; suppressing the battery fire with an unformulated, liquid composition including 98% VCX and 2% water; suppressing the battery fire with a VCX powder; suppressing the battery fire with a VCX powder comprising 100% VCX; suppressing the battery fire using a fire extinguisher including one of an unformulated, liquid composition including VCX and a VCX powder; and/or the battery fire suppression composition is a lithium-ion battery fire suppression composition and suppressing the battery fire comprises suppressing a lithium-ion battery fire.

### BRIEF DESCRIPTION OF THE DRAWINGS

FIG. 1 is a illustration of an embodiment of a fire suppression composition;

FIG. 2 is another embodiment of a fire suppression composition;

FIG. 3 is a flow chart of an exemplary method of making a fire suppression composition;

FIG. 4 is a flow chart of another exemplary method of making a fire suppression composition;

FIG. 5 is a flow chart of an exemplary method of suppressing a fire using a fire suppression composition;

FIG. 6 is a flow chart of another exemplary method of suppressing a battery fire using a fire suppression composition.

FIG. 7 is an illustration of an exemplary method of suppressing a fire using a fire suppression composition;

FIG. 8 is an illustration of another exemplary method of suppressing a fire using a fire suppression composition;

### DETAILED DESCRIPTION OF PREFERRED EMBODIMENTS

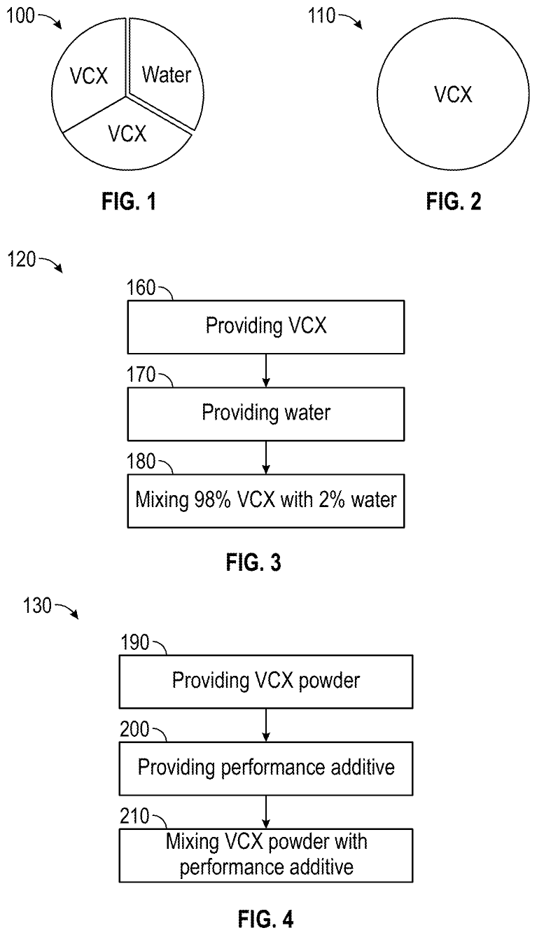

With reference generally to FIGS. 1-8, embodiments of battery fire suppression compositions 100, 110, methods of manufacture 120, 130, and methods of suppressing a fire 140, 150 will be described.

With reference to FIG. 1, an embodiment of an unformulated, liquid (aqueous colloidal dispersion) fire suppression composition 100, also referred to as EFX-HTS, comprises vermiculite ore concentrate (“VCX”) mixed with water. In the embodiment shown, the fire suppression composition 100 is by volume, 98% VCX and 2% water. The fire suppression composition 100 is 100% inorganic, consisting only of vermiculite and water; is highly heat and flame resistant and produces virtually no off-gassing or smoke; and is salt-free, ideal for use in end products where corrosion is a concern. The VCX in the fire suppression composition 100 is in the class of Micaceous Hydrated Silicate Minerals and the fire suppression composition 100 in the Planer Hydrous Phyllosilicate in Water Chemical Family. The VCX and water in the fire suppression composition 100 include the following weight (WT) percentages: Vermiculite (Magnesium Aluminum Iron Silicate) Mg1.8Fe2+0.9A14.3SiO10(OH)2·4(H2O) 5%-20% WT, Water (H2O) 80%-95% WT. The fire suppression composition 100 includes the following properties: Vermiculite Platelets Suspended in Water (physical state), Solids are Dark Greenish Brown to Bronze and Golden Brown (color), >1000 C/2120 F (@760 mm Hg) (boiling point), odorless (odor), neutral (pH), 1.1 (Water=1) (specific gravity), granulometry varies, but generally in the range 0.5 mm-15 mm.

With reference to FIG. 2, another embodiment of a fire suppression composition 110, also referred to as EFX Powder, comprises 100% VCX powder. The powdered suppression composition 110 possesses most of the same benefits as the unformulated, liquid fire suppression composition 100, but also includes additives to provide improved performance in areas such as adhesion, flexibility, and/or color and dyability.

With reference to FIG. 3, an exemplary method 120 of making the powdered fire suppression composition 100 comprises, at block 160, providing VCX, at block 170, providing water, and at block 180, mixing the VCX mixed with water, where by volume, the unformulated, liquid fire suppression composition 100 is 98% VCX and 2% water.

With reference to FIG. 4, an exemplary method 130 of making the powdered fire suppression composition 100 comprises, at block 190, providing VCX powder, which is 100% VCX, at block 200, providing performance additive (e.g., additive(s) to provide improved performance in areas such as adhesion, flexibility, and/or color and dyability), and at block 210, mixing the VCX powder with the performance additive to make the powdered fire suppression composition 100.

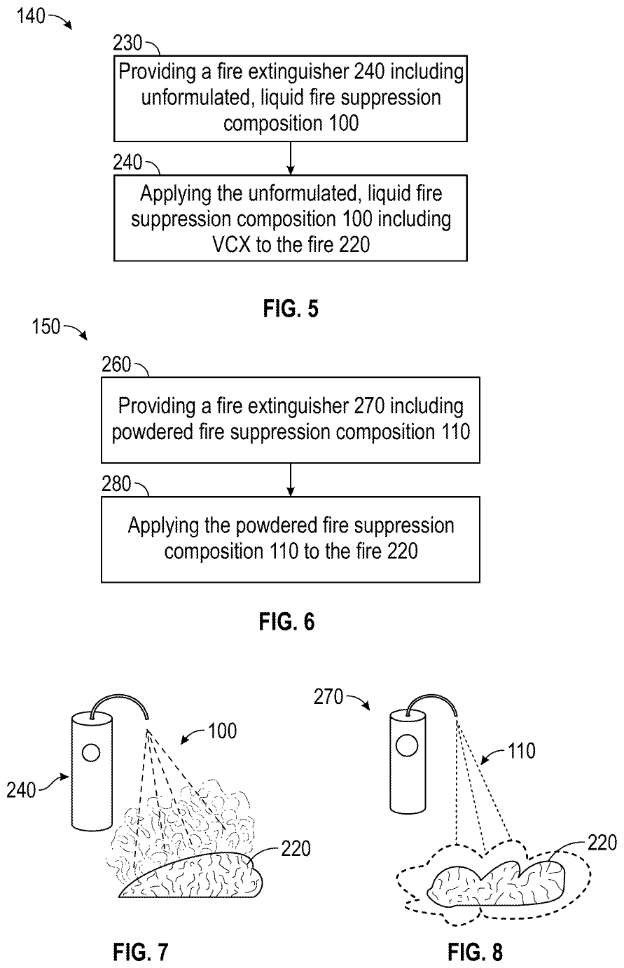

With reference to FIGS. 5 and 7, an exemplary method 140 of suppressing a fire 220 with the unformulated, liquid fire suppression composition 100 will be described. In the embodiments shown, the unformulated, liquid fire suppression composition 100 is a lithium-ion battery fire suppression composition and the fire 220 is a lithium-ion battery fire (e.g., rechargeable lithium-ion battery that caught fire). However, in alternative embodiments, the fire 220 may be a Class A fire, a flammable metal fire, or other type of fire that needs to be suppressed. The method 140 comprises, at block 230, providing a fire extinguisher 240 including the unformulated, liquid fire suppression composition 100, and, at block 250, applying the unformulated, liquid fire suppression composition 100 including VCX to the fire 220 until the fire 220 is suppressed.

With reference to FIGS. 6 and 8, an exemplary method 150 of suppressing a fire 220 with the powdered fire suppression composition 110 will be described. In the embodiments shown, the powdered fire suppression composition 110 is a powdered lithium-ion battery fire suppression composition and, as discussed above and incorporated herein, the fire 220 is a lithium-ion battery fire. The method 150 comprises, at block 260, providing a fire extinguisher 270 including the powdered liquid fire suppression composition 110, and, at block 280, applying the powdered fire suppression composition 110 including VCX to the fire 220 until the fire 220 is suppressed.

The fire suppression compositions 100, 110 are natural, mineral-based and environmentally friendly extinguishing agents for a variety of fires (e.g., lithium-ion battery fires, Class A fires, flammable metal fires). However, the high temperature capabilities of VCX in the fire suppression compositions 100, 110 make them ideal for fire-fighting Lithium-Ion battery fires. The fire suppression compositions 100, 110 are nearly twice as effective as water on class A fires, and VCX's excellent thermal insulation properties provides the capability and versatility to apply the fire suppression compositions 100, 110 as a fire retardant to help slow, stop and prevent the start of wildfires by making wildland fuels non-flammable. The fire suppression compositions 100, 110 are suitable for portable and fixed installations. The fire suppression compositions 100, 110 are environmentally friendly, non-hazardous, REACH exempt, inert, inorganic, have low SG 2.4-2.7 when expanded, have lower bulk density 70 kg-110 kg/Mt in their expanded state, low Mohs hardness, high temperature resistance up to 1400 c, high aspect ratio platelets up to 20,000/1, and Dv50 circa 30 microns.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in any following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I claim:

1. A battery fire suppression composition comprising vermiculite ore concentrate (VCX).

2. The battery fire suppression composition of claim 1, wherein the battery fire suppression composition is an unformulated, liquid composition.

3. The battery fire suppression composition of claim 2, wherein the battery fire suppression composition comprises VCX mixed with water.

4. The battery fire suppression composition of claim 3, wherein the battery fire suppression composition comprises 98% VCX mixed with 2% water.

5. The battery fire suppression composition of claim 1, wherein the battery fire suppression composition comprises VCX powder.

6. The battery fire suppression composition of claim 5, wherein the battery fire suppression composition comprises 100% VCX.

7. The battery fire suppression composition of claim 1, wherein the battery fire suppression composition is a lithium-ion battery fire suppression composition configured to suppress a lithium-ion battery fire.

8. A method of making the battery fire suppression composition of claim 1, comprising providing VCX.

9. The method of claim 8, wherein the method of making a battery fire suppression composition comprises mixing VCX with water to make an unformulated, liquid composition.

10. The method of claim 9, wherein mixing VCX with water comprises mixing 98% VCX with 2% water to make the unformulated, liquid composition.

11. The method of claim 8, wherein the method of making a battery fire suppression composition comprises making the battery fire suppression composition with a VCX powder.

12. The method of claim 11, wherein making the battery fire suppression composition comprises making the VCX powder with 100% VCX.

13. A method of suppressing a fire, comprising applying the battery fire suppression composition of claim 1 to the fire until the fire is suppressed.

14. The method of claim 13, wherein the method of suppressing a fire comprises a method of suppressing a lithium-ion battery fire with the battery fire suppression composition until the lithium-ion battery fire is suppressed.

15. The method of claim 14, wherein the battery fire suppression composition is an unformulated, liquid composition, and the method of suppressing a fire comprises suppressing the lithium-ion battery fire with the unformulated, liquid composition.

16. The method of claim 15, wherein the unformulated, liquid composition comprises VCX mixed with water.

17. The method of claim 16, wherein the unformulated, liquid composition comprises 98% VCX and 2% water.

18. The method of claim 14, wherein the battery fire suppression composition is a VCX powder, and the method of suppressing a fire comprises suppressing the lithium-ion battery fire with the VCX powder.

19. The method of claim 18, wherein the VCX powder is 100% VCX.

20. The method of claim 13, wherein the method of suppressing a fire comprises suppressing the lithium-ion battery fire using a fire extinguisher including one of an unformulated, liquid composition including VCX and a VCX powder.
